(19) United States
(12) Patent Application Publication
(10) Pub. No.: US 2007/0273201 A1
(43) Pub. Date: Nov. 29, 2007

(54) Brake System, Especially for Utility Vehicles

(75) Inventors: Joachim Scherrer, Herxheim (DE); Karl-Heinz Unser, Muggensturm (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/577,509

(22) PCT Filed: Sep. 21, 2004
(86) PCT No.: PCT/EP04/10565

§ 371 Date: Feb. 5, 2007

(30) Foreign Application Priority Data
Oct. 29, 2003 (EP) 103 50 560.1

(51) Int. Cl. B60T 8/34

(52) U.S. Cl. 303/113.1

(57) ABSTRACT

A brake system, in particular for utility vehicles is provided. A compressed-air-operated brake system (10) which is used, in particular, in utility vehicles, has a multi-circuit brake system having a front-axle brake circuit (20) and a rear-axle brake circuit (13). Here, a load emptying valve (12) is provided in the front-axle brake circuit (20) in order to influence the braking force which is adapted to the loading of the vehicle. The braking force or the brake pressure in the rear-axle brake circuit (13) is predefined by means of an automatically load-dependent braking force regulating process as a function of the load acting on the rear axle. The load emptying valve (12) is actuated by a fluidic connection (16) from the rear-axle brake circuit. A check valve (17) is provided for shutting off the fluidic connection (16) between the load emptying valve (12) and the rear-axle brake circuit (13) when a brake slip regulating process is carried out at the rear axle.

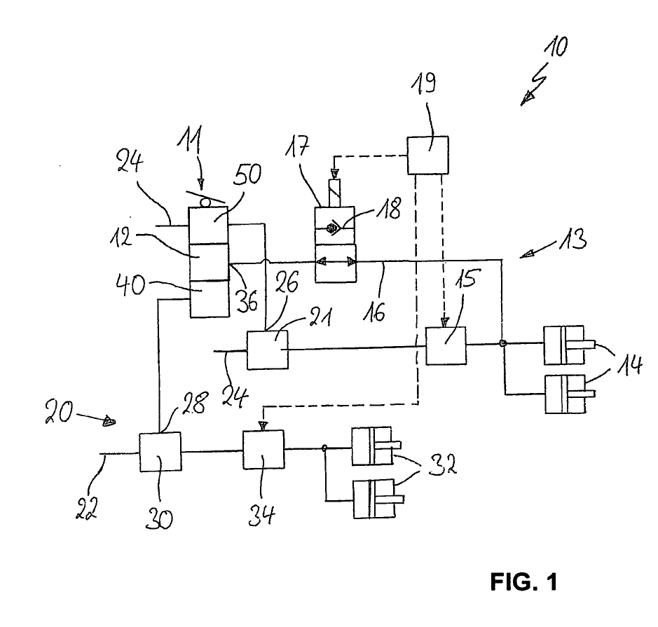

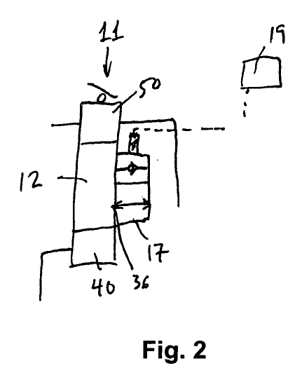

The invention relates to a brake system, in particular a compressed-air-operated brake system for utility vehicles.

Compressed-air-operated brake systems are used in particular in utility vehicles. They frequently have a multi-circuit brake system having a front-axle brake circuit and a rear-axle brake circuit. Since the loading of the utility vehicle, and thus the load exerted on the rear axle of the utility vehicle, can fluctuate to a very great extent, the rear-axle brake pressure or the rear axle braking force is adapted to the load by an automatic load-dependent brake pressure regulating process (ALB). When the load is low, only a low brake pressure or a low braking force is permitted in order to avoid excessively hard braking of the rear axle. In order to influence the braking force at the front axle, a load emptying valve is provided in the front-axle brake circuit and is generally integrated into the service valve. The braking force or the brake pressure at the front axle is influenced by means of the load emptying valve as a function of the brake pressure or braking force which is set at the rear axle. For this purpose, the load emptying valve is connected to the rear-axle brake circuit by a fluid connection.

An object of the invention is to further develop such a brake system with a load emptying valve in the front-axle brake circuit to the effect that the load-dependent brake pressure regulating process at the rear axle can be carried out by means of an existing brake slip regulating system, for example ABS.

This object is achieved by means of a brake system having the features of patent claim 1.

According to the invention, a check valve is provided for shutting off the fluid connection from the control inlet of the load emptying valve to the rear-axle brake circuit. As soon as a brake slip which exceeds a predefined slip threshold value is present at the rear axle, and the rear-axle brake slip regulating system is therefore activated (ABS regulating process) in order to influence the brake pressure at the rear axle, the check valve switches from its non-shutoff position of rest into its shutoff position. In this shutoff position, the flow of fluid from the load emptying valve in the direction of the brake cylinders of the rear axle is shut off so that the pressure which is present at the control inlet of the load emptying valve when the check valve is switched into the shutoff position can no longer be reduced. This means that even if the brake pressure at the rear axle drops because the ABS regulating process is active, the pressure at the control inlet of the load emptying valve is maintained. This leads to a situation in which the actuating pressure which is supplied to the load emptying valve is not unnecessarily reduced by the rear-axle brake slip regulating system when a brake slip regulating process is carried out at the rear axle. If the pressure prevailing at the control inlet of the load emptying valve were to be reduced by a brake slip regulating process, the front-axle brake pressure could be unnecessarily reduced by the load emptying valve, thus making the braking distance longer. By switching the check valve into its shutoff position when an ABS regulating process is taking place at the rear axle, the risk of an excessively low brake pressure at the front axle, and thus of a lengthened braking distance, is avoided.

Furthermore, this measure can be implemented easily and cost-effectively.

According to a preferred embodiment of the invention, the check valve is embodied as a two way valve with an integrated nonreturn valve. This is in particular a nonreturn valve which in the shutoff position permits a rise in pressure in the fluid path between the check valve and load emptying valve, and accordingly at the control inlet of the load emptying valve. As a result, it becomes possible that, if, by means of the rear-axle brake slip regulating system, the brake pressure at the rear axle is increased compared to the time when the check valve switches into its shutoff position, the pressure which is present at the control inlet of the load emptying valve is also increased. Consequently, brake pressures which are limited to an excessively low value at the front axle are avoided by this.

In one advantageous development of the invention, the check valve can be switched back in a defined fashion into its nonblocking position of rest. This permits a defined changeover from the blocking state of the check valve into its nonblocking state. A defined changeover ensures in particular that brake pressures and vehicle deceleration change only continuously and in particular with a limited gradient. As a result, operating states of the brake system which adversely affect the stability of the vehicle or changes in the behavior of the vehicle which surprise the driver are avoided.

A further refinement of the invention provides for the check valve to be integrated into another valve, in particular the service-brake valve or a relay valve which supplies the rear axle with feed pressure from the brake system. As a result, the number of components required to assemble the vehicle is reduced.

It is also advantageous if both the automatic load-dependent brake pressure regulating process and the brake slip regulating process are carried out at the rear axle by means of the same pressure regulating elements of the rear-axle brake circuit so that there is no need for an additional brake pressure regulator to influence the brake pressure as a function of the load.

Furthermore, the invention will be explained in more detail below with reference to the exemplary embodiment which is illustrated in the drawing. The single FIGURE shows part of a vehicle brake system in a schematic block illustration.

The vehicle brake system 10 has a front-axle brake circuit 20 and a rear-axle brake circuit 13 whose brake pressure can be set manually by means of a dual-circuit service-brake valve 11. The pressure supplied to the front-axle brake circuit 20 is provided via the connection 22 and the pressure supply to the rear-axle brake circuit 13 is provided via the connection 24 in a way which is known per se and not illustrated in more detail.

In a way which corresponds to the brake pedal position, a pilot pressure for the front-axle brake circuit 20 is supplied to a control inlet 28 of a front-axle relay valve 30 via a front-axle valve 40 of the service-brake valve 11. The front-axle relay valve 30 is connected to the connection 22 of the compressed air supply of the front-axle brake circuit 20 and sets the brake pressure which is requested at the control inlet 28 at the brake cylinders 32 of the front-axle brake circuit 20. At least one front-axle brake regulating valve 34 for regulating the brake pressure, for example for carrying out antilock regulating processes is arranged between the front-axle relay valve 21 and the brake cylinders 32 of the front axle. For this purpose, the front-axle pressure regulating valve 34 is actuated by a control device 19.

The design of the rear-axle brake circuit 13 is analogous to that of the front-axle brake circuit 20. A pilot pressure for the rear-axle brake circuit 13 is fed to a control inlet 26 of a rear-axle relay valve 21 from a rear-axle valve 50 of the service-brake valve 11 in accordance with the position of the brake pedal. The rear-axle relay valve 21 is connected via the connection 24 to the compressed air supply of the rear-axle brake circuit 13, and the brake pressure which is requested at the control inlet 26 is set by said rear-axle relay valve 21 at the brake cylinders 14 of the rear-axle brake circuit 13. At least one rear-axle pressure regulating valve 15 for regulating the brake pressure, for example for carrying out antilock regulating processes, is arranged between the rear-axle relay valve 21 and the brake cylinders 14 of the rear axle, said rear-axle pressure regulating valve 15 being actuated by the control device 19 for this purpose.

In the exemplary embodiment, an automatic load-dependent brake pressure regulating process is carried out by means of the control device 19 and the rear-axle pressure regulating valve 21. Here, the brake pressure in the rear-axle brake circuit 13 is limited or reduced as a function of the detected loading state to a maximum value corresponding to the detected loading state in such a way that early locking of the rear wheels during the braking process owing to the current rear axle load, for example when the vehicle is not laden, is prevented. The pressure regulating valve 15 is used here both for regulating the brake pressure within the scope of a brake slip regulating process and for carrying out the automatic load-dependent brake pressure regulating process.

What is referred to as a load emptying valve 12, which has the purpose of limiting the brake pressure at the front axle as a function of the brake pressure which is set at the rear axle, is integrated into the service-brake valve 11. For this purpose, the pilot pressure which is generated by the front-axle valve 40 of the service-brake valve for the control inlet 28 of the front-axle relay valve 21 is adapted by the load emptying valve 12 to the brake pressure which has been set at the rear axle, and thus to the loading state. For this purpose, the load emptying valve 12 can incrementally vary the pilot pressure generated by the front-axle valve 40 as a function of the brake pressure at the rear axle. For this purpose, the brake pressure which is present at the brake cylinders 14 of the rear axle is conducted to a control inlet 36 of the load emptying valve 12 via a fluid connection 16. The lower the pressure at the control inlet 36 of the load emptying valve, the lower also the pilot pressure at the control inlet 28 of the front-axle relay valve 30, and thus also the lower the maximum possible brake pressure at the front axle.

A check valve 17 is intermediately connected into this fluid connection 16, said check valve 17 being capable of being switched between an opened position of rest and a shutoff position which blocks the fluid connection 16 in the direction of the control inlet 36 of the load emptying valve 12 to the brake cylinders 14 of the rear-axle brake circuit 13. In the shutoff position of the check valve 17, a nonreturn valve 18 which is integrated into the check valve 17 ensures that in this context the pressure between the check valve 17 and the load emptying valve 12 can be made to follow a rise in the brake pressure at the brake cylinders 14 of the rear axle. The pressure at the control inlet 36 of the load emptying valve 12 can thus be increased, but not lowered, in the shutoff position of the check valve 17.

The check valve 17 is switched between the shutoff position and position of rest by corresponding actuation by means of the control device 19.

As an alternative to the illustrated preferred embodiment, it is also possible to construct the check valve 17 as one unit with the service-brake valve 11 or the rear-axle relay valve 21 so that a more compact design of the brake system 10 can be obtained.

If a brake slip regulating process, for example an antilock regulating process, is carried out at the rear axle during a braking process, the check valve 17 is switched into its shutoff position by means of the control unit 19 and the brake pressure prevailing in the fluid connection 16 at the time of switching is maintained at the control inlet 38 of the load emptying valve even if the brake pressure at the brake cylinders 14 of the rear axle is reduced, which is the case in particular during an antilock regulating process. This avoids a situation in which the influence exerted on the rear-axle brake pressure by means of the brake slip regulating process is present at the load emptying valve 12 via the fluid connection 16. The brake pressure at the front axle is WO2005/051739 PCT/EP2004/010565 therefore not limited at the rear axle via the load emptying valve during the brake slip regulating process.

However, if, during the brake slip regulating process at the rear axle, a brake pressure is set in the rear-axle brake circuit 13 which is higher compared to the brake pressure at the time of switching, this pressure is fed to the control inlet 36 of the load emptying valve 12 via the nonreturn valve 18. This ensures that when the brake pressure at the rear axle is increased, which is permitted by the brake slip regulating process, the maximum possible front-axle brake pressure is also correspondingly adapted by means of the load emptying valve 12.

After the brake slip regulating process has ended, the check valve 17 is actuated, for example by a correspondingly clocked actuation, in such a way that the pressure at the load emptying valve 12 is approximated to the rear-axle brake pressure in a defined, sufficiently continuous way. The change in pressure at the control inlet 36 of the load emptying valve 12 can depend here on the pressure difference between the pressure at the control inlet 36 of the load emptying valve 12 and the current brake pressure at the brake cylinders 14 of the rear axle. A value or a permitted value range which is to be complied with when the pressure at the control inlet 36 of the load emptying valve 12 is adapted can also be predefined for the change in pressure or the pressure gradient at the control inlet 36 of the load emptying valve 12.

1-6. (canceled)

7. A brake system comprising:
a front-axle brake circuit having a load emptying valve and front axle brake cylinder, the load emptying valve influencing a brake pressure at the front axle brake cylinders; and
a rear-axle brake circuit having an automatic load-dependent brake pressure regulator and rear axle brake cylinders, a brake pressure at the rear axle brake cylinders being influenced as a function of a load acting on a rear axle;
a fluid connection, the load emptying valve having a control inlet connected to the rear-axle brake circuit via the fluid connection;
a check valve provided in the fluid connection between the load emptying valve and the rear-axle brake circuit; and
a controller, the check valve being switched to a shutoff position when a brake slip regulating process is carried out at the rear axle by the controller so that the fluid connection from the load emptying valve in a direction of the rear axle brake cylinders is shut off;
the check valve including an integrated nonreturn valve, the nonreturn valve, in the shutoff position of the check valve, being connected to the fluid connection and preventing a drop in pressure at the control inlet of the load emptying valve, and permitting a rise in pressure at the control inlet of the load emptying valve.

8. The brake system as recited in claim 7 wherein in order to adapt the pressure at the control inlet of the load emptying valve to a current brake pressure at the rear axle brake cylinders, the check valve can be switched in a defined fashion from the shutoff position into a nonblocking position of rest.

9. The brake system as recited in claim 7 further comprising another valve, the check valve being integrated into the other valve.

10. The brake system as recited in claim 9 wherein the other valve is a service-brake valve or a relay valve supplying the rear axle with supply pressure of the brake system.

11. The brake system as recited in claim 7 wherein the automatic load-dependent brake pressure regulator carries out the brake slip regulating process carried out at the rear axle.

12. The brake system as recited in claim 7 wherein the brake system is a utility vehicle brake system.
